(19) United States
(12) Patent Application Publication
(10) Pub. No.: US 2025/0379869 A1
(43) Pub. Date: Dec. 11, 2025

(54) DISTRIBUTED PROCESSING PROVISION

(71) Applicant: Arm Limited, Cambridge (GB)

(72) Inventors: Vasileios Laganakos, Saffron Walden (GB); Nicholas John Cook, Kenilworth (GB); Remy Pottier, Grenoble (FR); Diya Soubra, Nice (FR)

(73) Assignee: Arm Limited, Cambridge (GB)

(21) Appl. No.: 18/877,113

(22) PCT Filed: Jun. 21, 2023
(86) PCT No.: PCT/GB2023/051628

§ 371 Date: Dec. 19, 2024

(30) Foreign Application Priority Data
Jun. 22, 2022 (EP) 22386039.6
Jul. 20, 2022 (GB) 2210627.2

(51) Int. Cl. H04L 9/40; G06F 9/50

(52) U.S. Cl. CPC H04L 63/102; G06F 9/5072; H04L 63/108

(57) ABSTRACT

A device and method, comprising: determining a quantum of data storage and processing capability/capacity to be offered for distributed processing; retrieving a current trustworthiness rating; constructing a features vector comprising quantum and rating; and entering a pool of candidates for selection by initiator by externalising the features vector. An initiator and method, comprising: determining a minimum quantum of storage and processing capability/capacity and minimum trustworthiness rating required for the processing task; constructing a requirement vector comprising quantum and rating; querying a network for a pool of candidates to perform the task; retrieving a features vector from a candidate; comparing features vector and requirement vector to determine which candidates meet the minimum quantum and rating required for the task; responsive to finding that a candidate meets the minima, selecting the candidate and dispatching task for processing at the candidate and rating the candidate on completion/non-completion/non-completion to standard required.

The present technology relates to as-required provision of assured distributed processing capabilities in networks.

Users who have access to devices that have the ability to operate as computers, for example, modern smart mobile (cellular) phones, may have a need for data processing capability that goes beyond what is available in their devices. For example, they may need to make use of large amounts of data, beyond the storage capacity of the device, or they may need to have long and complex processing tasks performed (or performed more quickly), beyond the processing power (or speed) of the device. In another example, an application that comprises multiple coordinated tasks may enhance its performance and the user's quality of experience if it has access to processing capability beyond the limited capabilities of a user's single device.

In the current environment, users are typically surrounded by a large number of highly capable computing-capable entities that they either completely own (like in their homes) or a mixture of what they own and do not own (like when they are on the move, or in an office/airport). These computing entities are not always operating to the maximum of their capabilities, and thus have spare capacity that is wasted. In addition, computing-capable entities today provide a variety of capabilities that are often isolated, and so not easily made available to any other reachable systems, unless the user goes through a tedious pairing process to create a connected mesh of pre-formed associations to tie devices and software together. Additionally, it may be difficult to assess the capabilities and level of trustworthiness of other reachable compute entities, via a connection fabric, in order to ad-hoc dispatch to it a computing task, when an initiator device needs that extra help in computing. Thus, while it may be possible to use localised networking (for example, Bluetooth® or other systems, wired or wireless, for connectivity) to pass portions of processing over to other devices, there are difficulties with doing so in a way that assures the effectiveness, efficiency and security of the process.

In a first approach to the many difficulties encountered in managing computing entities to achieve as-needed distributed processing of tasks, the present technology provides a method for operating a network-reachable recipient computing entity capable of offering resource for distributed processing, as defined by the appended claims. In a second approach, the present technology provides a method of managing a network-reachable distributed processing initiator, as defined by the appended claims.

The method may be computer-implemented, for example in the form of a computer program product that, when loaded into a computer system and executed, causes the computer system to perform the method according to the claims. There is further provided an apparatus comprising a memory and a processor provided with electronic logic circuitry operable to perform the method.

Implementations of the disclosed technology will now be described, by way of example only, with reference to the accompanying drawings, in which:

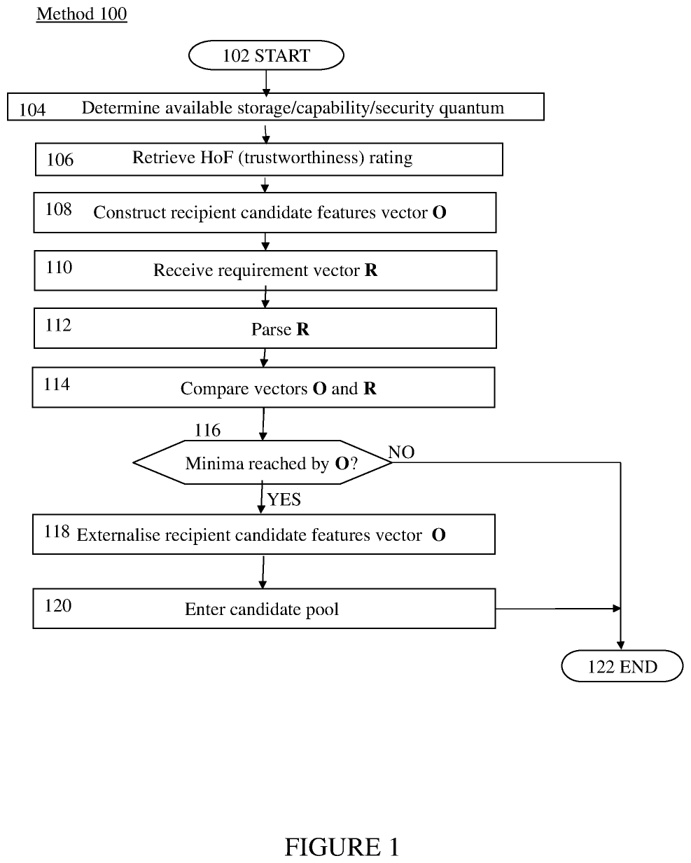

FIG. 1 shows a simplified view of a method of managing a recipient computing entity to achieve as-needed distributed processing of tasks according to an implementation of the presently described technology;

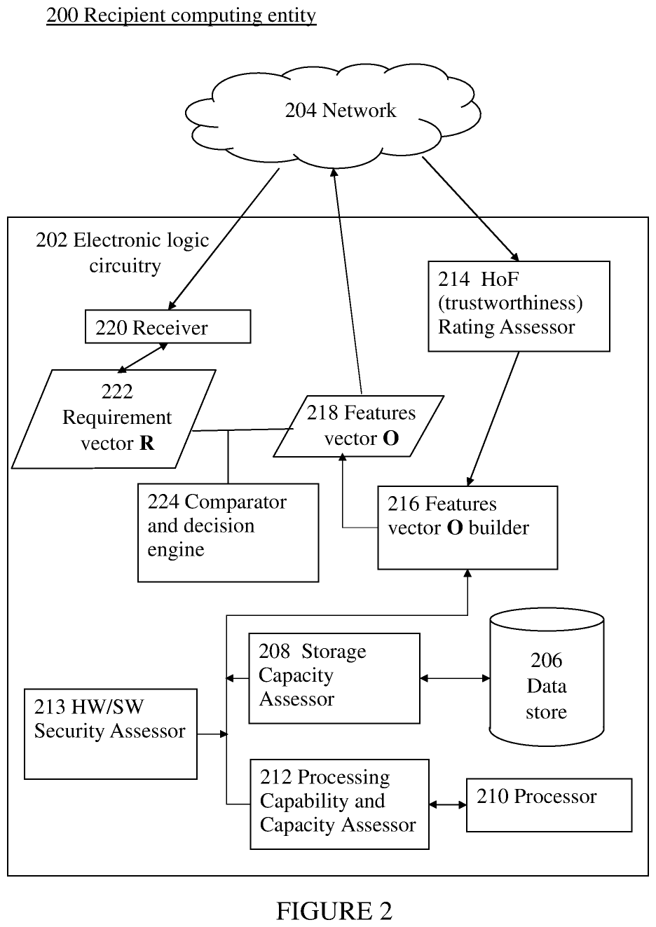

FIG. 2 shows a simplified representation of one possible arrangement of electronic circuit components to implement a recipient computing entity operable according to an implementation of the presently described technology;

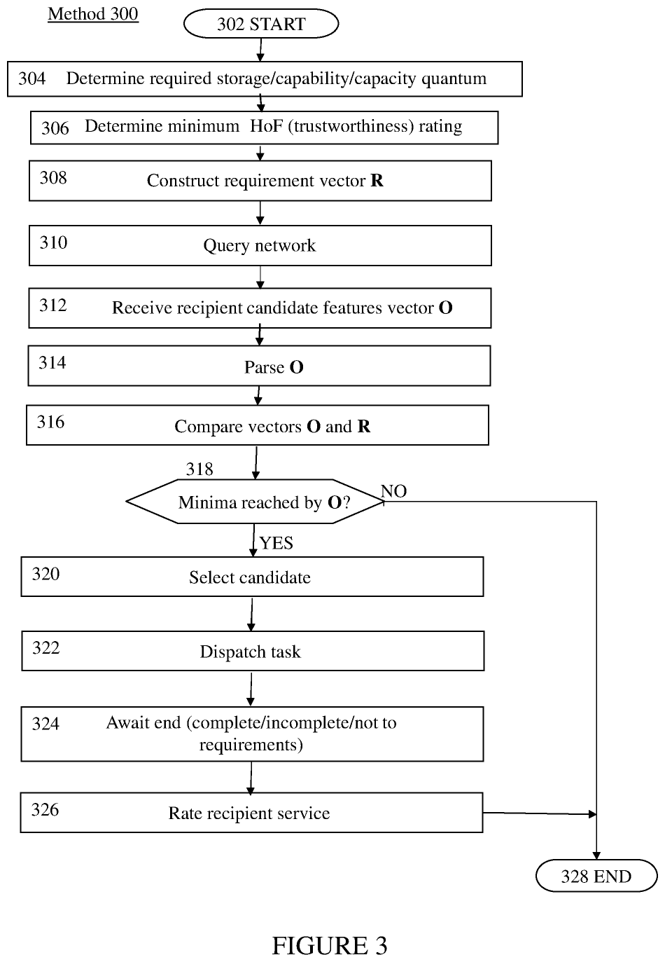

FIG. 3 shows a simplified view of a method of managing an initiator computing entity to achieve as-needed distributed processing of tasks according to an implementation of the presently described technology; and

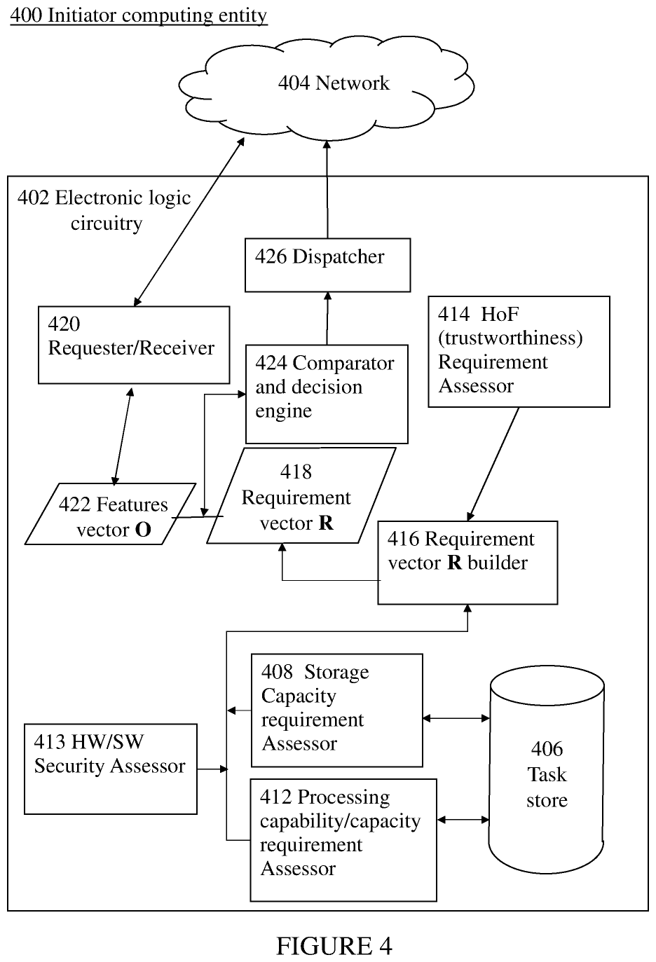

FIG. 4 shows a simplified representation of one possible arrangement of electronic circuit components to implement an initiator computing entity operable according to an implementation of the presently described technology.

As described above, it is desirable to provide user applications with the opportunity to access additional computing capacity when it is needed, without the need to acquire additional hardware on a permanent basis, and without the need to carry out manual remote device discovery and linking processes. To ensure that any remote processing is performed effectively and efficiently, it is desirable to confirm that any remote device that is considered as a candidate to take on a task genuinely has the capacity to do so. Further, to ensure security and integrity of the user's own device, it is also desirable to be assured that any remote processing is performed by a distributed device that is trustworthy and has the hardware or software security features required for the task, and to be assured that any trustworthiness rating is up to date.

The present technology operates in a world in which, driven by the Internet of Things trend that incorporates computing capabilities into everyday devices, users are surrounded by computing capacity in many forms. Televisions, watches, home control appliances, telephones, and many other everyday pieces of equipment in addition to conventional computing devices are equipped to intercommunicate and process information. In many cases, because of the use of standard microprocessors with special-purpose software, there may be general-purpose computing capacity built into the devices, a capacity that is often underutilised, and this available capacity could be exploited to beneficial effect by the present technology. At the same time, some devices that are called upon to perform tasks may be “underpowered” to perform those tasks efficiently and quickly, and they could benefit from the use of some of the ambient unused capacity that could be made available to them by the present technology.

Implementations of the present technology thus provide autonomous, dynamic, quick, intelligent, as-required, peer-to-peer discovery and selection of an appropriate, or the most appropriate computing entity (from all the reachable compute entities), to dispatch a computation task to, based on the entities' capabilities and level of trustworthiness established via other entities and past interactions. A computing entity can be a device such as a hardware platform, a system of linked devices, a virtual machine, or any other technology that can perform a computing task.

The present technology gives the user additional capabilities for a period of time, thus allowing most efficient and effective use of all computing resources available, and removing the need for users to acquire additional permanent computing capacity and then bear the burden of maintaining a large pool of computing power that may be rarely utilized to its full capability. The technology also allows applications to tap into ambient computing power and capacity while the user is on the move. In one implementation a candidate recipient entity may periodically generate a features vector that is ready to share those with any initiator. In another implementation, the candidate recipients have an “I'm ready to take tasks” flag, which makes them part of the virtual pool of candidate recipients, and they reply to different initiators when they are sent requirement vectors. In this implementation, recipients have an “available” flag (or not if they do not have any available capacity); an initiator first creates the tasks' requirements vectors; checks reachable entities with “available” flags; sends to the ones that are available the requirements feature vectors; recipients reply with their features vectors; the initiator chooses one or more recipients to perform tasks; sends them the tasks; waits for completion; and rates/scores the service of the recipient for the HoF score.

The effect is achieved by a network-reachable computing entity capable of offering resource for distributed processing and a distributed processing initiator operable to select from a pool of candidate computing entities according to their capabilities and levels of trustworthiness.

Broadly, one part of the present technology provides a way of operating a network-reachable computing entity that is capable of offering resource for distributed processing to a distributed processing initiator. The computing entity determines a quantum of its data storage and processing capability that is available to be offered for distributed processing, retrieves a current level of trustworthiness rating (either from its own storage or from an external entity), constructs a features vector that expresses at least the quantum and the rating, and then enters a pool of candidates that are available for selection by the distributed processing initiator by externalising the features vector.

Another part of the present technology provides a way of managing a distributed-processing initiator. The initiator, which is itself a computing entity, first determines a minimum quantum of data storage and processing capability that is required for a processing task. It then determines a minimum level of trustworthiness rating that is required for the processing task. It also determines the minimum level of security features required for the processing task—for example, if there is private data to be processed, it requires the presence of a secure container or the like at the recipient. Having established these minima, the initiator polls a network to discover a pool of candidate computing entities that are offering themselves as available to perform the processing task. After sending a requirements vector, the initiator retrieves a features vector from a candidate and analyses the features vector to determine whether the candidate meets the minimum quantum of data storage, processing capability and security features and the minimum level of trustworthiness rating that are required for said processing task. If the candidate meets the minima, the initiator selects the candidate and dispatches the task for processing by the selected candidate.

In a possible variant, rather than soliciting and selecting a first candidate that meets the minima, the initiator may collect the features vectors from a number of responses and may then compare them to select the best fit—an optimum resource-offering computing entity having characteristics that exceed the minima by the greatest margin, for example.

It will be immediately clear to one of ordinary skill in the computing art that a computing entity that is operable as a distributed processing initiator may also function as a resource-offering computing entity. In this scenario, the computing entity that operates on one occasion as an initiator to solicit help in completing a computing task, may on another occasion offer its spare computing resource to assist another initiator in completing its computing task. In one variant, the initiator or any of the resource-offering computing entities may be a static device. In all these circumstances, the ambient environment of other processing-capable devices may be static, at least for a time, or may change as portable devices are moved from place to place.

For better understanding, the present technology will be presented first in broad terms, with reference to the examples shown in the figures, and then a possible detailed implementation will be described by way of illustration. As will be immediately clear to one of ordinary skill in the computing art, many variants and additional features may be incorporated into the implementation with equal benefit to users of the present technology.

The present technology is operable in situations in which there is a need for collaborative distribution of tasks in a network of reachable devices, where, for example, a computing entity does not have sufficient resource to complete a task alone, but needs to call upon other resource owners to help. In another example, the user quality of experience may be enhanced if an application that comprises multiple tasks can have one or more of the tasks executed by a more computationally powerful device.

The computing entity that starts this collaboration is called an initiator and it can be, for example, a device that a user owns and carries about from place to place, such as a smart phone. The present technology is operable in this situation, when there are computing entities in the network vicinity that may or may not belong to the owner of the compute task initiator, that would potentially be of use in collaboration to complete tasks for which the initiator does not have adequate resource. The present technology addresses the first necessary assessment as to whether another computing entity is capable of completing a compute task at hand (for example, has spare storage, battery life, processing cycles, or the like). The technology also addresses the second necessary assessment as to whether another computing entity can be trusted with data that it does not own.

Throughout the present disclosure, the term “processing capability” should be understood to encompass a number of aspects. For example, the computing entity may have hardware-related performance characteristics such as available memory, memory organisation, processor and queue throughput, processor multitasking capacity, communication and dispatch latency, and the like. “Processing capability” may also encompass a computing entity's estimate of the bandwidth, latency, and energy cost to transfer the data from the initiator to the resource-offering entity and back from the resource-offering entity to the initiator. “Processing capability” may further comprise an estimate of task size or energy consumption requirements, including how a device is powered (mains or battery) and, if applicable, the battery level needed if the recipient computing entity is to be able to perform the task.

In implementations, the initiator and recipient computing entities may be wirelessly networked, or one or both may be statically networked vias cable or the like. In one example, a wirelessly networked computing entity may be accessible via Bluetooth®, which is characterised by being a low-energy consumer channel, but which has low communications bandwidth. On the other hand, an entity may be accessible via WiFi®, which consumes more energy, but has a higher bandwidth. Where the task requires little data to be transferred and/or has lax latency requirements the initiator might select the Bluetooth® attached computing entity, otherwise another computing entity with, for example, WiFi® connectivity could be used. Similarly, where devices are dependent upon energy-harvesting or battery power, it is important to assess whether there is sufficient stored power to complete the task. “Processing capability” may also encompass firmware and software support; for example, which tensors are supported, which system libraries are present, and the like. All these will affect any judgment made by the initiator as to the ability of the computing entity to perform the task to meet the initiator's requirements. Many other characteristics that make computing entities more or less suitable for selection will be immediately apparent to one of ordinary skill in the art. In an implementation of the present technology each initiator computing entity may comprise, among other components, an intelligent dispatcher supplied with a set of dispatching policies, a set of costs models encompassing the resource cost of various aspects of task processing, and a neural network for learning and applying the models.

Turning now to FIG. 1, there is shown a simplified view of a method 100 of managing a network-reachable resource-offering computing entity to achieve as-needed distributed processing of tasks according to an implementation of the presently described technology. The method begins at START 102, and at 104, the resource-offering computing entity determines a quantum of available data storage processing capability and security features provided. At 106, the resource-offering computing entity retrieves its Hall of Fame (trustworthiness) rating. This retrieval may be from local storage, or it may involve querying some external entity over the network. Using the quantum of available data storage and processing capability and the Hall of Fame rating, the resource-offering computing entity constructs 108 the recipient features vector O.

In one implementation, at 110, the recipient computing entity may then receive a requirement vector R from an external source over the network, and at 112, it parses requirement vector R ready for comparison at 114 with recipient features vector O.

In one alternative implementation, the process begins at 110 with the recipient computing entity receiving a requirements vector R, and then performs the steps shown here as 104, 106, 108, 112, before proceeding to 114.

In some circumstances, in which the environment is not trusted to maintain adequate security, the offer features vector O and requirement vector R may be implemented in forms that reveal only non-sensitive information. At 116, it is determined whether recipient features vector O achieves some minima determined by requirement vector R. If the recipient features vector O does not achieve some minima determined by requirement vector R, the resource-offering computing entity may pass immediately to END 122, without taking any action to externalise recipient features vector O or to enter the candidate pool for selection to perform a task on behalf of an initiator computing entity. As will be clear to one of ordinary skill in the art, END 122 represents the end of this iteration of the method 100, and further iterations may be performed. Thus, in this implementation, the resource-offering computing entity may receive the requirement vector and decide for itself that its resources are not sufficient to offer to perform a task on behalf of an initiator computing entity. In an alternative implementation, the resource-offering computing entity does not receive the requirement vector at 110 or perform the actions at 112, 114 and 116, but simply proceeds directly to next step 118.

In both of the two above-described implementations, at 118, the resource-offering computing entity externalises recipient features vector O and at 120 enters the candidate pool for selection to perform a task on behalf of an initiator computing entity. The resource-offering computing entity completes the current iteration of the method 100 at END 122. As stated above, it will be clear to one of ordinary skill in the art that END 122 represents the end only of this iteration of the method 100, and further iterations may be performed.

In this way, a resource-offering computing entity may use its analysis of its available computing facilities to construct and externalise its offer to take on processing of a task on behalf of an initiator.

FIG. 2 shows a simplified representation of one possible arrangement of electronic circuit components to implement a resource-offering computing entity 200 operable according to an implementation of the presently described technology. The resource offering computing entity, at its highest level, may comprise a virtual machine, but viewed at its lowest level it comprises electronic logic circuitry 202 attachable to a network 204. Network 204 may comprise any of the known forms of network, such as a wide area network, a local area network, a cloud computing infrastructure, a Bluetooth® short-range network, a WiFi® wireless network, ethernet, and the like. Electronic logic circuitry 202 of the resource offering computing entity may be continuously attached to network 204, or its attachment may be intermittent.

Electronic logic circuitry 202 comprises a data store 206 and a processor 210. The particular forms of data storage and processor are not material to the operation of the present technology, but it will be clear to one of ordinary skill in the art that both may take any form, provided only that it be suitable respectively for the storage and the processing of data. Electronic logic circuitry 202 further comprises storage capacity assessor 208 and processing capability/capacity assessor 212, responsible for determining the available storage and computing capabilities and capacity of the electronic logic circuitry 202. Electronic logic circuitry 202 further comprises a Hall of Fame (HoF) or trustworthiness rating assessor 214 that is operable to retrieve a HoF rating for the resource offering computing entity 200. The HoF rating may be retrieved from a local data store or it may be retrieved from an external source. In either case, the HoF rating assessor 214, storage capacity assessor 208 and processing capability/capacity assessor 212 provide their respective inputs to recipient features vector builder 216. Hardware/software security assessor 213 also provides its input to recipient features vector builder 216, which is operable in response to build recipient features vector O 218.

In some implementations, receiver 220 is operable to receive a requirement vector R 222 over network 204. Comparator and decision engine 224 may then compare recipient features vector O 218 with requirement vector R 222. In this implementation, should the comparison show that recipient features vector O 218 does not meet some minima established by requirement vector R 222, no further actions need to be initiated for this instance of the operation of electronic logic circuitry 202. If recipient features vector O 218 does meet the minima established by requirement vector R 222, or if this implementation of the electronic logic circuitry 202 does not comprise receiver 220 and comparator and decision engine 224, electronic logic circuitry 202 is operable to externalise recipient features vector O 218 over the network 204.

FIG. 3 shows a simplified view of a method 300 of managing an initiator computing entity to achieve as-needed distributed processing of tasks according to an implementations of the presently described technology. Method 300 commences at START 302 and at 304, the initiator computing entity analyses the task for which it needs assistance from resource providing computing entities, and determines the quantum of data storage and processing capability required to perform that task. At 306 the initiator computing entity further analyses the task for which it needs assistance from resource providing computing entities to determine the minimum Hall of Fame (HoF) or trustworthiness rating required to perform that task at the necessary level of reliability, security and integrity. At 308, the initiator computing entity takes the quantum of data storage and processing capability required and the HoF rating required, and constructs therefrom a requirement vector R. At 310 the initiator computing entity queries the network for any computing entities that are offering resource to assist in performing tasks, and at 312, the initiator computing entity receives at least one recipient features vector O.

At 314, initiator computing entity parses recipient features vector O in preparation for 316 at which a comparison is performed between recipient features vector O and requirement vector R to determine whether recipient features vector O achieves some minima determined by requirement vector R. If the recipient features vector O does not achieve some minima determined by requirement vector R, the resource-offering computing entity may pass immediately to END 328. It will be clear to one of ordinary skill in the art that END 328 represents the end only of this iteration of the method 300, and further iterations may be performed. If the recipient features vector O does achieve the minima determined by requirement vector R, the initiator computing entity may at 320 immediately select the candidate resource-offering computing entity, or it may perform further comparisons with recipient features vectors externalised by other resource-offering computing entities, to determine which offers the best fit for the task. At 322 the initiator computing entity dispatches the task to the selected candidate. The initiator computing entity awaits 324 the end of the dispatched task, which may comprise completion, non-completion or non-completion to the required standard, and at 326, it rates the recipient service by providing input to the HoF rating for the recipient. At END 328, the method 300 completes for the present iteration. Again, it will be clear to one of ordinary skill in the art that END 328 represents the end only of this iteration of the method 300, and further iterations may be performed.

In cases where a single application consists of, or can be decomposed into, multiple tasks or workloads, the initiator will perform the above process for each task of the application. For example, a recipient may be able to take two of the three tasks of an application and the third task may remain to be run on the Initiator. There may also be reasons why plural tasks of the same application must run on the same recipient: one could be that the two tasks communicate during their execution and they require minimum latency for that communication, or the two tasks may need to share data. The present technology is flexible enough to accommodate any such affinity decisions made by the initiator.

FIG. 4 shows a simplified representation of one possible arrangement of electronic circuit components to implement an initiator computing entity 400 operable according to an implementation of the presently described technology. The initiator computing entity 400, at its highest level, may comprise a virtual machine, but viewed at its lowest level it comprises electronic logic circuitry 402 attachable to a network 404. Network 404 may comprise any of the known forms of network, such as a wide area network, a local area network, a cloud computing infrastructure, a Bluetooth® short-range network, a WiFi® wireless network, and the like. Electronic logic circuitry 402 of the initiator computing entity may be continuously attached to network 404, or its attachment may be intermittent.

Electronic logic circuitry 402 comprises a task store 406. The particular form of data storage used is not material to the operation of the present technology, but it will be clear to one of ordinary skill in the art that it may take any form, provided only that it be suitable for the storage of task data relating to a task that is to be initiated by initiator computing entity 400. Electronic logic circuitry 402 further comprises storage capacity requirement assessor 408 and processing capability/capacity requirement assessor 412, responsible for determining the required storage and computing capabilities necessary to perform the task on behalf of initiator computing entity 400. Electronic logic circuitry 402 further comprises a Hall of Fame (HoF) or trustworthiness requirement assessor 414 that is operable to establish a minimum HoF rating for a resource offering computing entity to meet in order to perform the task on behalf of initiator computing entity 400. The HoF rating may be retrieved from a local data store or it may be retrieved from an external source. In either case, the HoF rating requirement assessor 414, storage capacity requirement assessor 408 and processing capability/capacity requirement assessor 412 provide their respective inputs to requirement vector builder 416. Hardware/software security assessor 413 may also provide input regarding the security requirements for the task. Responsive to receiving the input from storage capacity requirement assessor 408, processing capability/capacity requirement assessor 412 and HW/SW security assessor 413, requirement vector builder 416 is operable to build requirement vector R 418.

Electronic logic circuitry 402 further comprises requester/receiver 420, operable for attachment to and electronic communication with network 404. Requester/receiver 420 is operable to send a query over the network to discover candidates to perform tasks on behalf of initiator computing entity 400. Requester/receiver 420 is further operable to receive at least one recipient features vector O 422 over network 404. Comparator and decision engine 424 then compares a received recipient features vector O 418 with requirement vector R 422. Should the comparison show that recipient features vector O 418 does not meet the minima established by requirement vector R 422, no further actions need to be initiated for that instance of the operation of electronic logic circuitry 402. If recipient features vector O 418 does meet the minima established by requirement vector R 422, comparator and decision engine 424 may then be operable either to select the first available candidate that has met the minima, or may continue processing further recipient features vectors O 422 to establish a best fit candidate. Whichever candidate is selected, electronic logic circuitry 402 further comprises a dispatcher 426 operable to dispatch the task to the candidate for processing.

Electronic logic circuitry 402 may further be instrumented to monitor and assess the performance of selected candidates, in order to assign updated HoF ratings according to their efficacy in completing or not completing tasks.

In an implementation, the present technology introduces the following features vector, to be used by the compute entities that want to be part of the computing entities pool that can collaborate towards completing a computing task. The vector describes the capabilities of a computing entity without having to reveal sensitive information of the computing entity itself. In the present example, the vector comprises three parts: Primitives information, System information, and Hall of Fame (HoF) Score.
Primitives: contains low-level information about the computing entity: e.g., which processor core is used, the presence of CCA, which version of processor architecture is implemented, L1/L2 memory size, and other low-level hardware and firmware features. These characteristics can be used to recognise the computing entity, as well as to assess the entity's capabilities.
System: contains higher level information about the computing entity: e.g., which tensors of TensorFlow (or any other machine learning infrastructure) are supported, which system libraries are present, or simply whether the system is fundamentally capable of running computing task X. The last point allows the computing entity to share what computing tasks it can run without sharing any other sensitive information about itself, or the system setup directly.
HoF Score: reports what is the computing entity's level of trustworthiness established by other entities that have previously used this particular computing entity. Each time a computing task is completed on behalf of another computing entity the score rises. The more time that passes from the last time the computing entity completed a computing task for another computing entity, the more the score lowers by some decay factor.

Not all of these elements have to be present in a feature vector. In some instances, where an initial minimum level of trust has not yet been established between an initiator and a further computing entity, it may be sensible to limit the amount of information that is given away in the feature vectors that are externalised. The computing entity may be configured to only report just its HoF score and none of the primitives. In one alternative implementation, a neural network may be trained to infer from the Primitives and System information whether the initiator is indeed the device it claims to be.

The more information that is shared via the features vector, the more likely that the computing entity will be seen as trustworthy by the initiator. When more information about the computing entity is shared via the Primitives section, the traditional attestation with third party involvement can be used to check whether the computing entity is what it claims to be. If it is not what it claims to be, this could cause downgrading of its HoF score.

Here is an example of the discovery, selection, workload offload and results gathering process (the results can be either a single answer or a stream):
1. The initiator queries a reachable computing task recipient candidate about its features vector;
2. The computing task recipient responds with its recipient features vector;
3. The initiator analyses its requirement vector and deems that the computing task recipient is fit to run the computing task at hand and dispatches the task to it.
4. The computing task recipient completes the computing task and sends the results to the initiator—or opens a stream of results to send to the initiator.

There can be multiple instances of a relationship of one initiator to many workload recipient candidates, and the reachable computing entities form the neighbourhood of the initiator. The home environment is a good example of a neighbourhood, and it has the highest density of computing entities (outside the datacentre) and the devices around the user have a higher probability of being trusted by the user as they own them.

Any reachable computing entity that uses the present technology will be able to be part of the recipient computing task candidate pool. The pool can be extended to include computing entities outside the user's home, or when they are on the move or at work. As explained above, a computing entity that plays the role of initiator at one time can play the role of a workload recipient at another time.

If an initiator does not receive adequate responses from a first set of potential candidate recipients within its current scenario boundary, it may extend the scope of its query by expanding the current scenario boundary to include more of the reachable computing entities further removed in the network.

Sets of reachable computing entities may form into neighbourhoods, and the parameters defining neighbourhoods may be stored and reused by the computing entities when they are acting as initiators. This notion of neighbourhoods introduces the sense of dynamic neighbourhoods that change according to where the user or initiator computing entity is, such as home, living room, office, car, train, etc. In this case, the present technology, by using an external learner neural network can develop and learn the different scenarios according to the initiator computing entity's neighbourhood, thereby enabling the scenarioizing of the operations of the initiator, thus saving time in the decision-making process when determining which computing entities to dispatch tasks to.

Similarly, the operation of a neural network allows the use of one application where computing tasks start from the initiating device to vary according to the way the individual user interacts with it, hence enabling personalisation. The neural network learns how an application is used in the living room neighbourhood by one person as opposed to another person, by observing how the dispatcher of the initiating device dispatches computing tasks to the available workload recipients in the pool associated with, for example, the living room neighbourhood.

By means of its lightweight attestation solution, the present technology advantageously allows the initiating device to be able to offload a workload that handles, or contains, non-sensitive information to a computing entity that may lack advanced security features. The initiating computing entity can also rule that it will only share a computing task or data with the workload recipient having a feature vector that states that it is a particular processor architecture, such as an architecture that includes a secure enclave available to perform processing on behalf of an initiator.

The present technology also enables the implementation of transitive trust via the HoF rating: if device A trusts device C and device B trusts device A, then device B trusts device C.

The area for the selection of the best computing entity (CE) starts from where the user is (and usually initiated by the device they are using), but although the technology may make use of the neighbourhood concept, it may also be implemented in a location independent manner, and thus a neighbourhood can subsequently expand to any other reachable computing node, based on the priorities of the workload to be executed: latency, privacy, energy consumption and the like.

Thus, in its various implementations, the present technology can be summarised as comprising two main scenarios according to the following listings of processing steps. The listings use the following abbreviations:
1. Distributed processing initiator (DPI)
2. Distributed processing initiator's requirement vector (DPI_RV)
3. Distributed processing recipient (DPR)
4. Distributed processing recipient features vector (DPR_FV)

Scenario 1 is the simpler of the implementations, and may be useful in keeping the number of communication interactions low because the DPI requirement vector is not transmitted.
Scenario 1: DPI requirement vector DPI_RV stays at the DPI. The DPR always sends its DPR_FV.
1. DPI->generates requirement vector (DPI_RV)
2. DPI->requests recipient features vector DPR_FV from DPR
3. DPR->generates recipient features vector (DPR_FV)
4. DPR->sends DPR_FV to DPI
5. DPI->Analyses DPI_RV and DPR_FV to determine which DPR to use.

Scenario 2 is the more complex, but advantageously allows a reduction in the number of candidates that respond to the DPI's query.
Scenario 2: DPI requirement vector DPI_RV is sent to DPR. The DPR may or may not send its DPR_FV to the DPI depending on the overlap between the DPR_FV and DPI_RV.
1. DPI->generates requirement vector (DPI_RV)
2. DPI->sends its requirement vector (DPI_RV) to DPR
3. DPR->generates recipient feature vector (DPR_FV)
4. DPR->potentially analyses its DPR_FV and DPI_RV to see if there is overlap
5. DPR->sends DPR_FV to DPI if there is a good overlap between the DPR_FV and DPI_RV; otherwise potentially the DPR indicates that it cannot perform the task, or simply does not respond with an attempt to join the candidate pool.
7. DPI->Analyses DPI_RV and received DPR_FVs to determine which DPR to use.

The flexibility of this technology allows multiple different scenarios of operation and is not restricted to the two scenarios illustrated above. Other scenarios could include but are not limited to, for example, the DPI sending its DPR_FV to the DPI only as a response to its availability. In another example, the DPI sends a restricted DRI_RV to reachable DRPs. Because the present technology is operable at the infrastructure level, scenarios can be covered and expressed by an extendable protocol that is suitable for modification to suit the efficacy, security, reliability and integrity requirements of the owners of the devices.

As will be appreciated by one skilled in the art, the present technique may be embodied as a system, method or computer program product. Accordingly, the present technique may take the form of an entirely hardware embodiment, an entirely software embodiment, or an embodiment combining software and hardware. Where the word “component” is used, it will be understood by one of ordinary skill in the art to refer to any portion of any of the above embodiments.

Furthermore, the present technique may take the form of a computer program product embodied in a non-transitory computer readable medium having computer readable program code embodied thereon. The computer readable medium may be a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction-set to high-level compiled or interpreted language constructs.

It will also be clear to one of skill in the art that all or part of a logical method according to embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored using fixed carrier media.

In one alternative, an embodiment of the present techniques may be realized in the form of a computer implemented method of deploying a service comprising steps of deploying computer program code operable to, when deployed into a computer infrastructure or network and executed thereon, cause said computer system or network to perform all the steps of the method.

In a further alternative, an embodiment of the present technique may be realized in the form of a data carrier having functional data thereon, said functional data comprising functional computer data structures to, when loaded into a computer system or network and operated upon thereby, enable said computer system to perform all the steps of the method.

It will be clear to one skilled in the art that many improvements and modifications can be made to the foregoing exemplary embodiments without departing from the scope of the present technique.

1. A method of operating a network-reachable recipient computing entity capable of offering resource for distributed processing to an initiator, comprising:
determining a quantum of data storage and processing capability to be offered for distributed processing;
retrieving a current level of trustworthiness rating;
constructing a recipient features vector comprising at least said quantum and said rating; and
entering a pool of candidates for selection by said distributed processing initiator by externalising said recipient features vector.

2. The method according to claim 1, further comprising: receiving by the recipient computing entity a requirement vector from an initiator; comparing the requirements vector with its recipient features vector; and
responsive to the recipient features vector not meeting a minimum quantum of capability or a minimum level of trustworthiness as defined in the requirement vector, not externalising said recipient features vector to enter said pool of candidates.

3. The method according to claim 1, said initiator entering a further pool of candidates by constructing and externalising its own recipient features vector to at least one further initiator.

4. The method according to claim 1, said retrieving a current level of trustworthiness rating comprising retrieving an updated level of trustworthiness rating based on a most recent use by an initiator.

5. The method according to claim 1, said retrieving a current level of trustworthiness rating comprising retrieving an updated level of trustworthiness rating based on a completion or non-completion or non-completion to a required standard defined by said requirements vector of a prior task for an initiator.

6. The method according to claim 1, said retrieving a current level of trustworthiness rating comprising retrieving a time-decayed level of trustworthiness rating based on a delay since a last use by a initiator.

7. The method according to claim 1, said constructing a recipient features vector further comprising adding device characteristics data.

8. The method according to claim 1, said recipient features vector further comprising a security features descriptor.

9. The method according to claim 1, said entering a pool of candidates comprising entering a scenario-specific pool of candidates.

10. The method according to claim 1, further comprising the initiator:
determining a minimum quantum of data storage and processing capability required for a processing task;
determining a minimum level of trustworthiness rating required for said processing task;
constructing a requirement vector comprising at least said minimum quantum of data storage and processing capability and minimum level of trustworthiness rating;
querying a network for a pool of candidates to perform said processing task;
receiving a recipient features vector from a candidate having entered the pool of candidates;
comparing said recipient features vector and said requirement vector to confirm whether said candidate meets the minimum quantum of data storage and processing capability and minimum level of trustworthiness rating required for said processing task; and
responsive to finding that at least one said candidate meets said minima, selecting at least one said candidate and dispatching said task for processing at said at least one candidate.

11. The method according to claim 10, said querying a network comprising establishing a scenario boundary to delimit a current pool of candidates.

12. The method according to claim 10, further comprising awaiting ending on completion of said task by the selected said candidate and updating a trustworthiness rating for said selected candidate.

13. The method according to claim 10, further comprising awaiting ending without completion of said task or without completion of said task to a required standard defined by said requirements vector by the selected said candidate and downgrading a trustworthiness rating for said selected candidate.

14. The method according to any of claim 10, further comprising annotating said trustworthiness rating with a timestamp marking said ending of said task.

15. The method according to claim 14, further comprising initiating a time-decay process of said trustworthiness rating based on said timestamp marking said ending of said task.

16. The method according to claim 10, said selecting at least one said candidate and dispatching said task comprising selecting plural candidates and dispatching plural subtasks according to at least a subtask affinity requirement.

17. An apparatus comprising a data store, a processor, and dedicated electronic logic circuitry embodying the method according to claim 1.

18. A computer program comprising computer program code to, when loaded into a computer system and executed thereon, cause said computer system to perform all the steps of the method of claim 1.
